(19) United States
(12) Patent Application Publication
(10) Pub. No.: US 2015/0273674 A1
(43) Pub. Date: Oct. 1, 2015

(54) AUTO-ADJUSTING CONTROL DEVICE FOR ADJUSTING CLAMPING SIZS OF A C-RING NAIL GUN

(71) Applicant: Testo Industry Corp., Taichung City (TW)

(72) Inventor: Roger SHEN, Taichung City (TW)

(73) Assignee: TESTO INDUSTRY CORP., Taichung City (TW)

(21) Appl. No.: 14/225,613

(22) Filed: Mar. 26, 2014

(51) Int. Cl. B25C 1/06

(52) U.S. Cl. CPC B25C 1/06

(57) ABSTRACT

An auto-adjusting control device for adjusting clamping sizes of a C-ring nail gun has a microprocessor, a motor drive unit, and a status detection module electrically connected to each other. The motor drive unit is electrically connected to a motor that drives the C-ring nail gun. The status detection module detects a current value of the motor drive unit and a position of a guiding rod of the C-ring nail gun. The microprocessor determines if the C-ring nail gun has completed a clamping movement according to the current value. The status detecting module also determines if the C-ring nail gun has completed the clamping movement according to the positions of the guiding rod. By determining if a C-ring has clamped an article with the status detecting module, the clamping sizes of the C-ring nail gun can be adjusted.

### BACKGROUND OF THE INVENTION

1. Field of the Invention

The present invention relates to an adjusting control device, especially to an adjusting control device for adjusting clamping sizes of a C-ring nail gull.

2. Description of the Prior Art(s)

Conventional C-ring nail guns are mostly driven by pneumatic power. The conventional C-ring nail gun has a ring clamping unit, a cylinder, a piston, and a guiding rod. The clamping unit has a clamping mouth. The piston is slidably mounted in the cylinder. The guiding rod has a front end facing the clamping unit, a rear end connected to the piston, and two expanding wheels mounted on the front end of the guiding rod. During operation, the piston is pushed by air pressure and drives the guiding rod to move forward. The guiding rod pushes a C-ring in the clamping mouth to a front end of the clamping mouth. Then the piston as well as the guiding rod is moved backwardly, such that the expanding wheels force the clamping mouth to close. Accordingly, the C-ring in the clamping mouth is formed as a circle in order to facilitate clamping.

However, the conventional C-ring nail gun is driven by air pressure, and the air pressure is provided from an air compressor or a high pressure air source. Volume of the air compressor is huge, such that the air compressor is hard to be moved and is inconvenient for use.

For convenience of use, another conventional C-ring nail gun is designed to be driven by electric power. In the conventional electric-powered C-ring nail gun, the piston is driven by an electric motor. The electric motor is electrically connected to a control circuit and batteries. The electric motor works in coordination with a spring to drive the guiding rod to move back and forth. Thus, the conventional electric-powered C-ring nail gun can be used for clamping and is convenient for use and carriage.

Since the electric motor needs large torque to drive the guiding rod and push the spring, the electric motor is regarded as a large current load. Thus, relays that sustain high current are needed in the control circuit. Accordingly, space in the conventional electric-powered C-ring nail gun is occupied by the relays, and cannot be added with other control circuits. Moreover, clamping sizes of the conventional electric-powered C-ring nail gun are controlled by a micro switch. The electric motor may be unable to drive the guiding rod to trigger the micro switch and may stall due to thicknesses or numbers of the articles that need to be clamped, such that reliability of the conventional electric-powered C-ring nail gun is low.

To overcome the shortcomings, the present invention provides an auto-adjusting control device for adjusting clamping sizes of a C-ring nail gun to mitigate or obviate the aforementioned problems.

### SUMMARY OF THE INVENTION

The main objective of the present invention is to provide an auto-adjusting control device for adjusting clamping sizes of a C-ring nail gun. The auto-adjusting control device has a microprocessor, a motor drive unit, a status detection module, and at least one display unit. The microprocessor receives at least one feedback signal and outputs multiple control signals according to the at least one feedback signal. The motor drive unit is electrically connected to the microprocessor and a motor, receives one of the control signals of the microprocessor, and controls operation of the motor according to the control signal that is received. The status detection module is electrically connected to the microprocessor, detects a current value of the motor drive unit or a clamping position of the C-ring nail gun, and sends the at least one feedback signal to the microprocessor. The at least one display unit is electrically connected to the microprocessor and displays status information of the status detection module. The microprocessor determines if the C-ring nail gun has forced a C-ring to clamp an article according to the at least one feedback signal from the status detection module, outputs one of the control signals to drive the motor drive unit to rotate, and outputs another one of the control signals to display the status information on the at least one display unit.

When the current value exceeds a preset value, the microprocessor determines that the C-ring nail gun has completed a clamping movement. When the guiding rod reaches one of two opposite extreme positions, the status detecting module also determines that the C-ring nail gun has completed the clamping movement. By determining if a C-ring has clamped an article with the status detecting module, the clamping sizes of the C-ring nail gun can be adjusted.

Other objectives, advantages and novel features of the invention will become more apparent from the following detailed description when taken in conjunction with the accompanying drawings.

### BRIEF DESCRIPTION OF THE DRAWINGS

FIG. 1 is a circuit block diagram of a first embodiment of an auto-adjusting control device for adjusting clamping sizes of a C-ring nail gun in accordance with the present invention; and

FIG. 2 is a circuit block diagram of a second embodiment of an auto-adjusting control device for adjusting clamping sizes of a C-ring nail gun in accordance with the present invention.

### DETAILED DESCRIPTION OF THE PREFERRED EMBODIMENTS

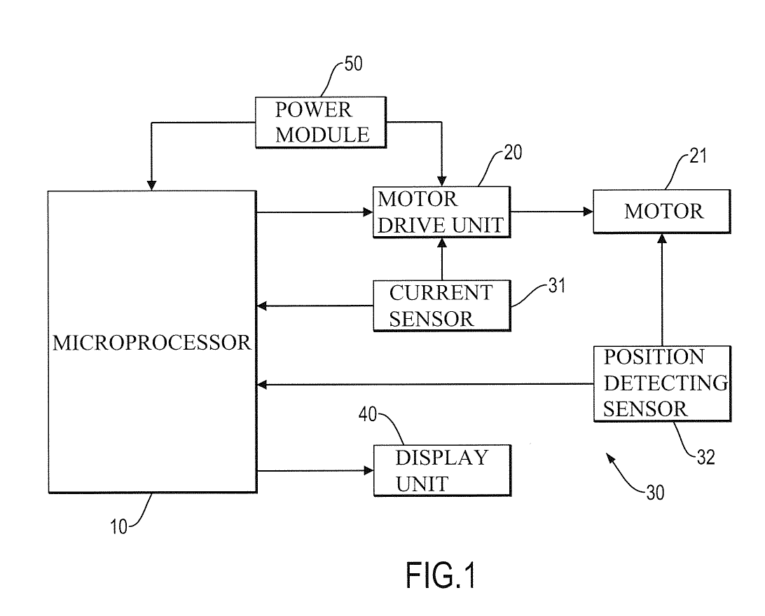

With reference to FIG. 1, a first preferred embodiment of an auto-adjusting control device for adjusting clamping sizes of a C-ring nail gun in accordance with the present invention is electrically connected to an electric-powered C-ring nail gun and comprises a microprocessor 10, a motor drive unit 20, a status detection module 30, at least one display unit 40, and a power module 50. The motor drive unit 20 is electrically connected to the microprocessor 10 and a motor 21. The motor 21 is connected to a guiding rod of the electric-powered C-ring nail gun and drives the guiding rod to move back and forth. The guiding rod pushes C-rings into a clamping unit to clamp articles. The status detection module 30 is electrically connected to the motor drive unit 20 and the microprocessor 10 to detect a status of the motor drive unit 20. Alternatively, the status detection module 30 is electrically connected directly to the motor 21 and the microprocessor 10 to detect a status of the motor 21. The at least one display unit 40 is electrically connected to the microprocessor 10. The power module 50 is electrically connected to the microprocessor 10 and the motor drive unit 20 to provide direct current to the microprocessor 10 and provide electric power to the motor drive unit 20 for driving the motor 21.

In the first preferred embodiment, the status detection module 30 includes a current sensor 31 and a position detecting sensor 32. The current sensor 31 is electrically connected to the motor drive unit 20 and the microprocessor 10. The current sensor 31 detects a current value of the motor drive unit 20 and sends a feedback signal to the microprocessor 10 according to the current value of the motor drive unit 20. The position detecting sensor 32 is electrically connected to the motor 21 and the microprocessor 10. The positioning detecting sensor 32 detects status information from the motor 21 or the electric-powered C-ring nail gun, and sends a feedback signal to the microprocessor 10 according to the status information. The status information that the microprocessor 10 detects from the electric-powered C-ring nail gun includes movements of the guiding rod or whether the guiding rod has reached one of two opposite extreme positions. When the guiding rod reaches one of the extreme positions, the microprocessor 10 controls the motor drive unit 20 to stop the motor 21 from operating, or to further drive the motor 21 to rotate reversely after the motor 21 stops operating. Thus, the C-ring would not over-clamp the article, thereby avoiding damage to the article.

The microprocessor 10 includes multiple input/output ports, and receives the feedback signals from the current sensor 31 and the position detecting sensor 32 via the input/output ports. Then the microprocessor 10 23 computes and outputs multiple control signals to the motor drive unit 20 according to the feedback signals, such that the motor drive unit 20 controls operation of the motor 21 according to the control signals from the microprocessor 10. If the current value that the current sensor 31 detects exceeds a preset current value set in the microprocessor 10, it means that operating resistance of the motor 21 increases and the guiding rod has pushed the clamping unit to force the C-ring to clamp the article. The microprocessor 10 determines that the C-ring nail gun has completed a clamping movement, and the microprocessor 10 records and counts clamping times of the C-ring nail gun. Furthermore, the microprocessor 10 records and calculates a starting time and an operation time of the motor 21 in order to detect whether the position detecting sensor 32 works normally. If the motor 21 works for a reasonable time and the position detecting sensor 32 does not send the feedback signal, the position detecting sensor 32 may have broken down. Therefore, the microprocessor 10 stops the motor 21 from operating and sends a failure warning.

The at least one display unit 40 displays information stored in the microprocessor 10 or displays other status information such as: clamping times of the C-ring nail gun, remaining electric power of the power module 50, abnormal status, the failure warning, operation time of the motor 21, the current value of the motor drive unit 20, or timing status. In the first preferred embodiment, each of the at least one display unit 40 may be a light-emitting diode (LED) display or a liquid crystal display module (LCM) display. Alternatively, each of the at least one display unit 40 may include an LED display and an LCM display. Furthermore, the power module 50 may be a battery set, a battery pack, or a direct current source.

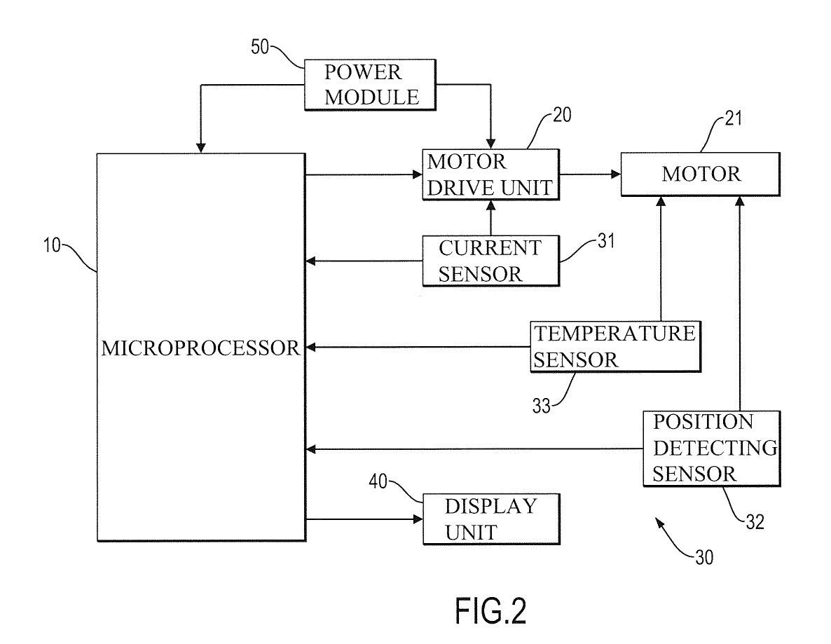

With reference to FIG. 2, in the second preferred embodiment, the status detection module 30 further includes a temperature sensor 33. The temperature sensor 33 is mounted on a housing of the motor 21 or on another position where temperature rises easily. The temperature sensor 33 is electrically connected to the microprocessor 10 via the input/output ports of the microprocessor 10, and sends a feedback signal to the microprocessor 10 according to the temperature of the motor 21. Thus, the microprocessor 10 monitors the temperature of the motor 21 when the motor 21 is under operation. The at least one display unit 40 displays the temperature of the motor 21. If the temperature of the motor 21 is higher than a preset temperature, such as 50° C. or 60° C., the microprocessor 10 stops the motor 21 from operating, sends a failure warning, and displays the failure warning on the display unit 40.

The auto-adjusting control device for adjusting the clamping sizes of the C-ring nail gun as described has the following advantages. The microprocessor 10 determines status of the article in order to estimate if the C-ring has clamped the article according to the current value and the position of the guiding rod. Therefore, the auto-adjusting control device for adjusting the clamping sizes of the C-ring nail gun of the present invention solves the problem that a conventional C-ring nail gun is unable to adjust clamping sizes with a mechanical micro switch. Moreover, with the at least one display unit 40 displaying the status information or the failure warnings, users can know operation status of the C-ring nail gun and repair the C-ring nail gun when the C-ring nail gun fails.

The motor drive unit 20, the current sensor 31, and the position detecting sensor 32 are made of semiconductor devices with high precision and small sizes, can drive high current loads to operate with reduced sizes, and can improve accuracy of detecting results. Therefore, the auto-adjusting control device for adjusting the clamping sizes of the C-ring nail gun of the present invention solves the problems that the conventional C-ring nail gun needs high current relays and the mechanical micro switch that occupy large space.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An auto-adjusting control device for adjusting clamping sizes of a C-ring nail gun, the auto-adjusting control device comprising:
a microprocessor receiving at least one feedback signal and outputting multiple control signals according to the at least one feedback signal;
a motor drive unit electrically connected to the microprocessor and a motor, receiving one of the control signals of the microprocessor, and controlling operation of the motor according to the control signal that is received by the motor drive unit;
a status detection module electrically connected to the microprocessor, detecting a current value of the motor drive unit or a clamping position of the C-ring nail gun, and sending the at least one feedback signal to the microprocessor; and
at least one display unit electrically connected to the microprocessor and displaying status information of the status detection module;
wherein the microprocessor determines if the C-ring nail gun has forced a C-ring to clamp an article according to the at least one feedback signal from the status detection module, outputs one of the control signals to drive the motor drive unit to rotate, and outputs another one of the control signals to display the status information on the at least one display unit.

2. The auto-adjusting control device as claimed in claim 1, wherein the status detection module includes
a current sensor electrically connected to the motor drive unit and the microprocessor, the current sensor detecting the current value of the motor drive unit and sending one of the at least one feedback signal to the microprocessor according to the current value of the motor drive unit; and
a position detecting sensor electrically connected to the motor and the microprocessor, detecting the status information from the motor and sending one of the at least one feedback signal to the microprocessor according to the status information.

3. The auto-adjusting control device as claimed in claim 2 further comprising a power module electrically connected to the microprocessor and the motor drive unit.

4. The auto-adjusting control device as claimed in claim 3, wherein each of the at least one display unit displays clamping times of the C-ring nail gun, remaining electric power of the power module, abnormal status, failure warning, operation time of the motor, the current value of the motor drive unit, or timing status.

5. The auto-adjusting control device as claimed in claim 1, wherein each of the at least one display unit is a light-emitting diode (LED) display or a liquid crystal display module (LCM) display.

6. The auto-adjusting control device as claimed in claim 2, wherein each of the at least one display unit is an LED display or an LCM display.

7. The auto-adjusting control device as claimed in claim 3, wherein each of the at least one display unit is an LED display or an LCM display.

8. The auto-adjusting control device as claimed in claim 4, wherein each of the at least one display unit is an LED display or an LCM display.

9. The auto-adjusting control device as claimed in claim 1, wherein each of the at least one display unit includes an LED display and an LCM display.

10. The auto-adjusting control device as claimed in claim 2, wherein each of the at least one display unit includes an LED display and an LCM display.

11. The auto-adjusting control device as claimed in claim 3, wherein each of the at least one display unit includes an LED display and an LCM display.

12. The auto-adjusting control device as claimed in claim 4, wherein each of the at least one display unit includes an LED display and an LCM display.

13. The auto-adjusting control device as claimed in claim 1, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

14. The auto-adjusting control device as claimed in claim 2, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

15. The auto-adjusting control device as claimed in claim 3, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

16. The auto-adjusting control device as claimed in claim 4, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

17. The auto-adjusting control device as claimed in claim 5, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

18. The auto-adjusting control device as claimed in claim 8, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

19. The auto-adjusting control device as claimed in claim 9, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.

20. The auto-adjusting control device as claimed in claim 12, wherein
the status detection module further includes a temperature sensor electrically connected to the microprocessor, detecting a temperature of the motor, and sending one of the at least one feedback signal to the microprocessor according to the temperature of the motor; and
the at least one display unit displays the temperature of the motor.
